(19) United States
(12) Patent Application Publication
(10) Pub. No.: US 2009/0248564 A1
(43) Pub. Date: Oct. 1, 2009

(54) SETTLEMENT PRICING FOR CENTRALLY CLEARED SWAPS

(75) Inventors: Kevin Fallon, Salem, WI (US); Ketan Patel, Hanover Park, IL (US); Moody Hadi, Chicago, IL (US); Suneel Iyer, Naperville, IL (US); Stephane Rio, Seine (FR)

Correspondence Address: BANNER & WITCOFF, LTD.,;ATTORNEYS FOR CLIENT NO. 006119, 10 SOUTH WACKER DRIVE, SUITE 3000, CHICAGO, IL, 60606, US

(73) Assignee: CHICAGO MERCANTILE EXCHANGE, INC., Chicago, IL (US)

(21) Appl. No.: 12/324,107

(22) Filed: Nov. 26, 2008

Related U.S. Application Data
(60) Provisional application No. 60/991,103, filed on Nov. 29, 2007.

(51) Int. Cl. G06Q 40/00

(52) U.S. Cl. 705/37

(57) ABSTRACT

Methods are provided to determine a settlement price for an over-the-counter exchange traded financial instrument. The method includes receiving swap curves from a plurality of market makers and identifying missing data points in the curves. A repair mode may be determined for curves identified as missing data. The curves may be repaired based on the determined repair mode. The selected curves including the repaired curves may be blended together to derive a final settlement prices for each of a plurality of standardized centrally cleared swaps. The financial instruments may include Euro denominated interest rate swaps, U.S. denominated interest rate swaps, or OIS interest rate swaps.

This application claims the benefit of U.S. Provisional Application No. 60/991,103, filed Nov. 29, 2007, and entitled Settlement Pricing for Centrally Cleared Swaps, the entire disclosure of which is hereby incorporated by reference.

### FIELD OF THE INVENTION

The invention relates generally to operating a market, and particularly to settlement of centrally cleared derivative products traded in a market.

### BACKGROUND

Over-the-counter (OTC) derivative products, such as negotiable financial instruments, generally refer to custom-tailored, negotiated contracts such as, for example, derivatives of stocks, commodities, securities, interest rates, indices, futures and forwards, options and foreign currencies which are bought and sold directly between parties. These financial instruments are generally referred to as over-the-counter because they are not exchange-traded or listed. An OTC product is a binding agreement or contract having a limited lifetime and may entail efforts for transaction processing and post-transaction administration. Substantial resources may be expended by both parties to monitor and ensure compliance throughout the life of the OTC product.

One example of an OTC derivative product is an interest rate swap (IRS) transaction. With an interest rate swap, parties agree to exchange streams of future interest payments based on a specified principal or notional amount. Types of IRS transactions or contracts include: an exchange of interest streams where one stream is based on a floating rate and the other interest stream is based on a fixed rate, and/or an exchange of two interest streams based floating rates having different underlying indices. Each stream may be referred to as a leg. Swaps are often used to hedge certain risks, for instance, interest rate risk. They may also be used for speculative purposes.

An example of a swap includes a plain fixed-to-floating, or “vanilla,” interest rate swap. The “vanilla” or exemplary interest rate swap includes an exchange of interest streams where one interest stream is based on a floating rate and the other interest stream is based on a fixed rate in the same currency. In the exemplary swap, one party makes periodic interest payments to the other based on a variable interest rate. The variable rate may be linked to a periodically known or agreed upon rate for the term of the swap such as the London Interbank Offered Rate (LIBOR). In return for the stream of payments based on the variable rate, the other party may receive periodic interest payments based on a fixed rate. The payments are calculated over the notional amount. The first rate is called variable, because it is reset at the beginning of each interest calculation period to the then current reference rate, such the LIBOR published rate. Often, at least one of the legs to a swap has a variable rate which may be based on any agreed upon factors such as a reference rate, the total return of a swap, or an economic statistic.

Another example of a swap is a total return swap (also known as total rate of return swap, or TRORS). A total return swap is a swap in which one party receives interest payments based on an underlying asset (plus any capital gains/losses) over the payment period, while the other receives a specified fixed or floating cash flow. The total return is the capital gain or loss, plus any interest or dividend payments. The specified fixed or floating cash flow is typically unrelated to the credit worthiness of the reference asset. The underlying asset may be any asset, index, or collection of assets. The parties gain exposure to the return of the underlying asset, without having to actually hold the asset. That is, one party gains the economic benefit of owning an asset without having the asset on its balance sheet, while the other (which does retain that asset on its balance sheet) has protection against a potential decline in its value. An equity swap is a variation of a total return swap. The underlying asset in an equity swap may be a stock, a basket of stocks, or a stock index.

Regardless of the type of transaction, the expiration or maturity of the future streams of interest payments may occur well into the future. Thus, each of the parties or counterparties may have a book or portfolio containing multiple transactions, IRS transactions, etc., having a variety of maturity dates. This large and complex book or portfolio of transactions may require the parties to expend substantial resources tracking and managing the contracted products. Moreover, for each of the transactions within the portfolio, each of the parties maintains an element of risk that one of its counterparties from a previous transaction will default on a payment.

Centrally cleared swaps provide processes and methods for monitoring, managing and clearing custom-tailored contracts or OTC financial products. It is preferable for the centrally cleared swaps to have a value that can be easily tracked or monitored. With a centrally cleared swap, it is preferable to periodically determine the value, or profits and losses, associated with open positions in the swap. The value may be determined prior to expiration of the swap through a marked-to-market accounting process. However, it is preferable to determine the value of the open position according to an agreed upon standard or benchmark. Currently, there are no standard or benchmarks available for determining the value of an open position in the centrally cleared swap. It would be desirable to provide apparatuses, processes and methods for settling centrally cleared swaps.

### SUMMARY

Methods for settling centrally cleared swaps such as, for example, interest rate swap (IRS) transactions are disclosed. The disclosed processes and methods are not limited to centrally cleared IRS transactions or any particular pre-defined and/or standardized over-the-counter financial products or instruments. Instead, the processes and methods may be generally applied to any wide variety of negotiable financial instruments and investment vehicles.

In an embodiment, a method of determining periodic settlement prices for centrally cleared swaps is disclosed. The method includes receiving swap curves from a plurality of market makers and identifying missing and/or inaccurate data points in the curves. In another embodiment, a repair mode may be determined for curves identified as missing data. The curves may be repaired based on the determined repair mode.

The selected curves including the repaired curves may be blended together to derive a final settlement price for each of a plurality of standardized centrally cleared swaps. The financial instruments may include Euro denominated interest rate swaps, U.S. denominated interest rate swaps, or OIS interest rate swaps.

Other embodiments are disclosed, and each of the embodiments can be used alone or together in combination. Additional features and advantages of the disclosed embodiments are described in, and will be apparent from, the following Detailed Description and the Figures.

### BRIEF DESCRIPTION OF THE FIGURES

Systems, methods and apparatuses for pre-execution credit controls are illustrated by way of example and not limited in the accompanying figures in which like reference numerals indicate similar elements.

FIG. 1 illustrates an exemplary computer system that may be used to implement various aspects of the invention.

FIG. 2 illustrates an exemplary computer network system that may be used to implement various aspects of the invention.

FIG. 3 illustrates a method of determining a settlement price in accordance with at least one aspect of the invention.

FIG. 4 illustrates price curves for a financial instrument in accordance with at least one aspect of the invention.

FIG. 5 illustrates an exemplary embodiment for determining an end-of-day settlement price for a financial instrument in accordance with an aspect of the invention.

FIG. 6 illustrates a second exemplary embodiment for determining an end-of-day settlement price for a financial instrument in accordance with an aspect of the invention.

FIG. 7 illustrates a screen shot of a Forward Curve Matrix used to calculate forward rates for interest rate swaps in accordance with an aspect of the invention.

FIG. 8 illustrates another screen shot of Forward Curve Matrix used to calculate forward rates for interest rate swaps in accordance with an aspect of the invention.

### DETAILED DESCRIPTION

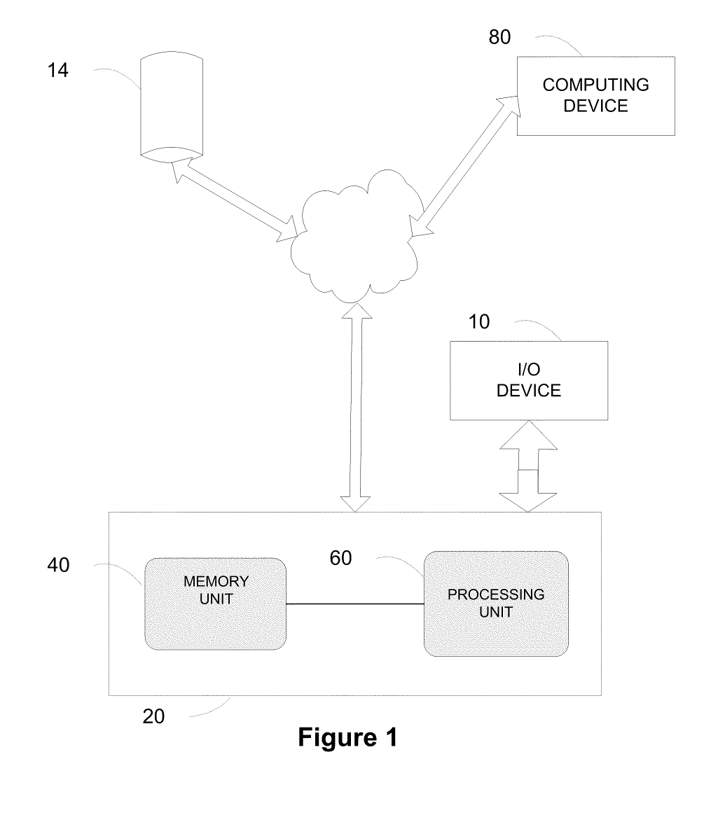

An example of a suitable operating environment in which various aspects of the invention may be implemented is shown in FIG. 1. The operating environment is only one example of a suitable operating environment and is not intended to suggest any limitation as to the scope of use or functionality of the invention. The processing unit 60 of computer system 20 executes computer-executable instructions in accordance with aspects of the invention. Memory unit 40 may store computer-executable instructions, which are executed by the computer system 20. The computer-executable instructions may be comprised of modules in accordance with aspects of the invention.

The computer system 20 may have one or more input/output devices 10 (e.g., keyboard, mouse, voice automation, screen, kiosk, handheld computing device display, voice, etc.). Database 14 may be a third-party database containing, for example, information such as the LIBOR rate or other information useful in determining market values. The database 14 may be connected through wired or wireless communication networks to the computer system 20. Computing device 80 may be a laptop computer, handheld computing device, or any other mobile computing device. In one embodiment in accordance with the invention, a user of computing device 80 can remotely communicate via the Internet to computer system 20 at a clearinghouse or exchange.

Of course, numerous additional servers, computers, handheld devices, personal digital assistants, telephones and other devices may also be connected to exchange computer system 20. Moreover, one skilled in the art will appreciate that the topology shown in FIG. 1 is merely an example and that the components shown in FIG. 1 may be connected by numerous alternative topologies.

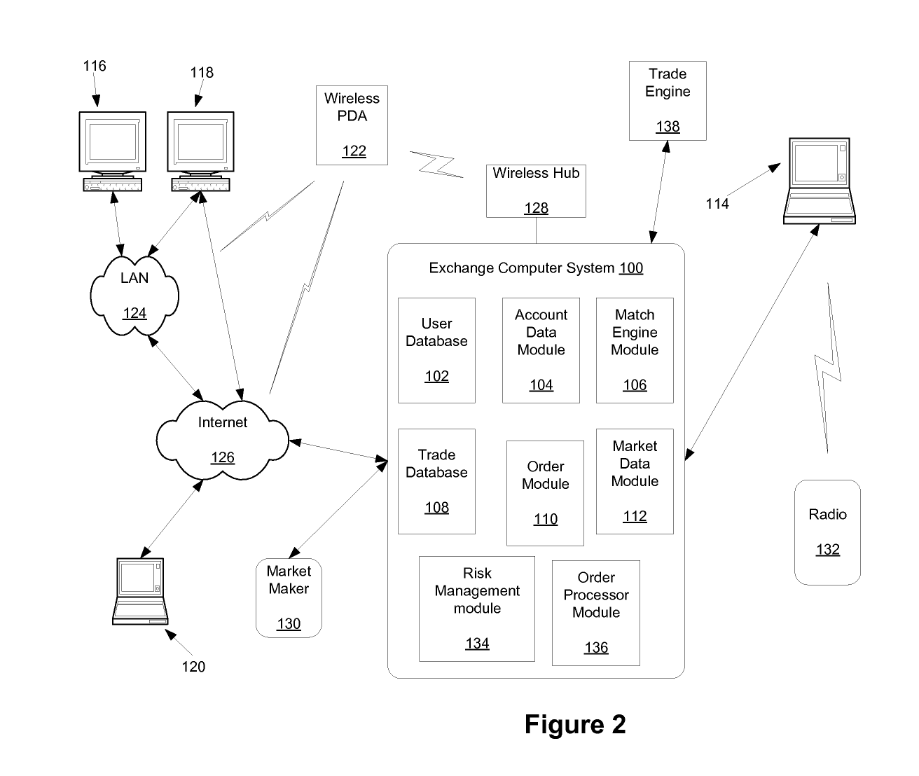

In addition, aspects of the present invention are preferably implemented with or used in conjunction with second exemplary computer system and network. For instance, an exemplary trading network environment for implementing trading systems and methods is shown in FIG. 2. An exchange computer system 100 receives orders and transmits market data related to orders and trades to users or customers. Exchange computer system 100 may be implemented with one or more mainframe, desktop or other computers. A user database 102 includes information identifying traders and other users of exchange computer system 100. Data may include user names and passwords.

An account data module 104 may process account information that may be used during trades. A match engine module or trade matching engine 106 is included to match bid and offer prices. Match engine module 106 may be implemented with software that executes one or more algorithms for matching bids and offers. A trade database 108 may be included to store information identifying trades and descriptions of trades. In particular, a trade database may store information identifying the time that a trade took place and the contract price. An order module 110 may be included to compute or otherwise determine current bid and offer prices. A market data module 112 may be included to collect market data and prepare the data for transmission to users. A risk management module 134 may be included to compute and determine a user's risk utilization in relation to the user's defined risk thresholds. An order processor module 136 may be included to decompose delta based and bulk order types for processing by order book module 110 and trade matching engine 106.

The trading network environment shown in FIG. 2 includes computer devices 114, 116, 118, 120, and 122. Each computer device includes a central processor that controls the overall operation of the computer and a system bus that connects the central processor to one or more conventional components, such as a network card or modem. Each computer device may also include a variety of interface units and drives for reading and writing data or files. Depending on the type of computer device, a user can interact with the computer with a keyboard, pointing device, microphone, pen device or other input device.

Computer device 114 is shown directly connected to exchange computer system 100. Exchange computer system 100 and computer device 114 may be connected via a T1 line, a common local area network (LAN) or other mechanism for connecting computer devices. Computer device 114 is shown connected to a radio 132. The user of radio 132 may be a trader or exchange employee. The radio user may transmit orders or other information to a user of computer device 114. The user of computer device 114 may then transmit the trade or other information to exchange computer system 100.

Computer devices 116 and 118 are coupled to a LAN 124. LAN 124 may have one or more of the well-known LAN topologies and may use a variety of different protocols, such as Ethernet. Computers 116 and 118 may communicate with each other and other computers and devices connected to LAN 124. Computers and other devices may be connected to LAN 124 via twisted pair wires, coaxial cable, fiber optics or other media. Alternatively, a wireless personal digital assistant device (PDA) 122 may communicate with LAN 124 or the Internet 126 via radio waves. PDA 122 may also communicate with exchange computer system 100 via a conventional wireless hub 128. As used herein, a PDA includes mobile telephones and other wireless devices that communicate with a network via radio waves.

FIG. 1 also shows LAN 124 connected to the Internet 126. LAN 124 may include a router to connect LAN 124 to the Internet 126. Computer device 120 is shown connected directly to the Internet 126. The connection may be via a modem, DSL line, satellite dish or any other device for connecting a computer device to the Internet.

One or more market makers 130 may maintain a market by providing constant bid and offer prices for a derivative or security to exchange computer system 100. Exchange computer system 100 may also exchange information with other trade engines, such as trade engine 138. One skilled in the art will appreciate that numerous additional computers and systems may be coupled to exchange computer system 100. Such computers and systems may include clearing, regulatory, and fee systems.

The operations of computer devices and systems shown in FIG. 2 may be controlled by computer-executable instructions stored on computer-readable medium. For example, computer device 116 may include computer-executable instructions for receiving order information from a user and transmitting that order information to exchange computer system 100. In another example, computer device 118 may include computer-executable instructions for receiving market data from exchange computer system 100 and displaying that information to a user.

Of course, numerous additional servers, computers, handheld devices, personal digital assistants, telephones and other devices may also be connected to exchange computer system 100. Moreover, one skilled in the art will appreciate that the topology shown in FIG. 2 is merely an example and that the components shown in FIG. 1 may be connected by numerous alternative topologies.

In an aspect of the invention, an exchange may provide one or more venues for the purchase and sale of various types of products including financial instruments such as stocks, bonds, futures contracts, options, cash, swaps, and other financial instruments. A transaction is the purchase or sale of the financial instruments, as well as similar rights and obligations. Generally, an exchange establishes specifications for the products traded at the exchange. The specifications may define the product traded in the market, minimum quantities that must be traded, and a minimum price increment in which the product can be traded.

The exchange may also provide one or more venues for financial instruments that are typically traded in the OTC market. For example, an exchange may provide a venue for transactions for standardized centrally cleared swaps. An order for the standardized swap may be placed via a web-based or other electronic order interface. The order may be transmitted to the exchange where it may be matched by an electronic matching engine, or module, with another order having similar terms, or transaction parameters. Examples of electronic trading interfaces or front-end trading applications that enable access to the electronic trading platforms are offered by Independent Software Vendors (ISVs), brokerage firms, and other application providers. A list of some such platforms is available at http://www.cme.com/trading/get/isvappl.html. An example of an electronic matching engine or module includes the CME Globex® platform.

In an aspect of the invention, a trader may send a request for quote to one or more potential counterparties for an exchange traded OTC product. The trader may transmit the request using an electronic messaging broker system or request for quote system. Potential counterparties may respond to the request by supplying proposed terms and transactions parameters. The trader may, in turn, negotiate with the respondent and/or agree or accept the terms of the proposed transaction. The terms and transaction parameters may relate to one or more transactions for interest rate swaps. Other terms and parameters may include positions of the parties, notional value of the interest rate swap, and other data related. A party, in this exemplary embodiment, may enter into an over-the-counter transaction with the counterparty at a negotiated interest rate, either a fixed or floating rate. The principal or notional amount of the swap may be utilized to calculate the interest stream which is the subject of the transaction.

Once the order for a standardized swap is matched, the parties to the swap transaction, such as traders, brokerages and/or other persons who may trade products at or with the exchange, have an open position with respect to the financial transaction. In an embodiment of the invention, each party may carry accounts with an authorized clearing firm. The clearing firm guarantees the accounts to a central clearing house associated with the exchange.

In an aspect of the invention, the clearing firm accounts are marked-to-market and subject to performance bond requirements established by the exchange. The performance bonds represent an amount of protection against potential losses that the clearing firm must maintain. The amount of the performance bond may be periodically determined. In an embodiment, should the performance bond fall below a threshold, the funds in the account must be replenished. To determine if the performance bond needs to be replenished, all open positions held in a product are periodically marked-to-market. The open positions may be marked-to-market during the trading session as well as at the end of the trading session. On occasion, the open positions may be marked-to-market more frequently.

In an aspect of the invention, open positions may be marked-to-market by comparing the open position to a current settlement price for associated financial product. A net change in the value of the open position may be computed and a net change associated with all the open positions held by the trader determined. In an embodiment, to the extent that the net change shows that the trader's account is below the threshold, the trader will be required to replenish the funds in the account. Periodic settlement of accounts assures that all parties involved in trading through an exchange are solvent and can meet their obligations to one another and to the exchange.

In another aspect of the invention, settlement prices for a product traded in a market are periodically established. Settlement prices for a product may be established using a number of methods. In an embodiment, a settlement committee may determine a settlement price. The settlement committee may consist of several traders who review and discuss trading data to determine the settlement price considered to represent fair value at a discrete moment in time.

In another embodiment, a settlement price may be established according to the price of a last trade executed before a predetermined settlement time. Moreover, in other embodiments a settlement price may be responsive to trading conditions for a product. As such, parameters that are computed from trading data are compared to determine the exact procedure for determining the settlement price. An example of one such parameter is a quotient of open interest of a product having a particular contract expiration month (“contract month”) divided by open interest of the product including all of the contract months.

In an additional aspect of the invention, a settlement price for a product may be calculated using a volume weighted average price (“VWAP”) for the product. The VWAP may be determined according to:

$$VWAP = ( \frac{{\sum }_{k} ( {Quantity}_{k} ) \cdot ( {Price}_{k} )}{{\sum }_{k} ( {Quantity}_{k} )} )$$

where k represents number of trades occurring during a period of time, Quantityₖ represents quantity of product traded, and Priceₖ represents a corresponding price.

In another aspect of the invention, a fixing methodology may be used to define a transparent, unambiguous, robust and fast process of determining end-of-day settlement prices for financial instruments such as interest rate swaps. In an embodiment, fixing refers to the determination of end-of-day settlement prices for financial instruments. The methodology may also serve as a basis to provide real time indicative prices to the market which ultimately may be the settlement price.

In an aspect of the invention, settlement prices for EUR and U.S. denominated swaps may be determined. In an embodiment, settlement prices may be determined for 360 forward starting financial instruments. The forward starting instruments may include three consecutive start dates with quarterly tenors extending from three months to thirty years. For exemplary purposes in describing various aspects of the invention, the three start dates in the remainder of this document may be referred to as series-1, series-2, and series-3, respectively. Furthermore, to articulate the methodology in an exemplary embodiment of the invention, one may consider USD against Libor 3M denominated swaps (code U3L) as a reference. For U3L swaps, a fixing for 360 instruments (360 forward starting instruments) may be determined. In addition, further exemplary swap products may include USD OIS swaps (code UDF), EUR against Euribor 6M swaps (code E6E), and EUR against EONIA CME swaps (code EDO).

In another aspect of the invention, real-time communication of the settlement prices may be provided on an electronic platform so that pricing information is disseminated simultaneously to market data vendors and other entities such as the clearing house. The prices may be disseminated to TIPS (Theoretical Intraday Pricing System) via ITC (a proprietary market data format used by the market data vendors as well), and also as a file for contingency purposes.

In an embodiment, indicative prices (white prices) may display “real time continuous settlement prices with the same methodology.” Moreover, in an embodiment, the end-of-day settlement procedure may occur every day at 10:00 AM CT for EUR and 2:00 PM CT for USD. Those skilled in the art will realize that different times may be used depending on the type of financial product.

In accordance with an aspect of the invention, end-of-day settlement prices may be determined using one of two modes, a nominal mode and a backup mode. In an embodiment, the nominal mode may process curves from market makers and/or a curve from an external source of an OTC market. In an aspect of the invention, various algorithms may be used to repair and then blend prices into one reliable settlement rate curve.

In an embodiment, four active market makers may be used to provide price curves. Those skilled in the art will realize that the number of market makers providing price curves may be larger or smaller depending upon numerous factors. Furthermore, in return for the incentives associated with the market maker privileges, the market makers may be required to provide tradable quotes for some swaps and indicative quotes for every swap (bids and offers for tradable prices, MIDs for indicative prices).

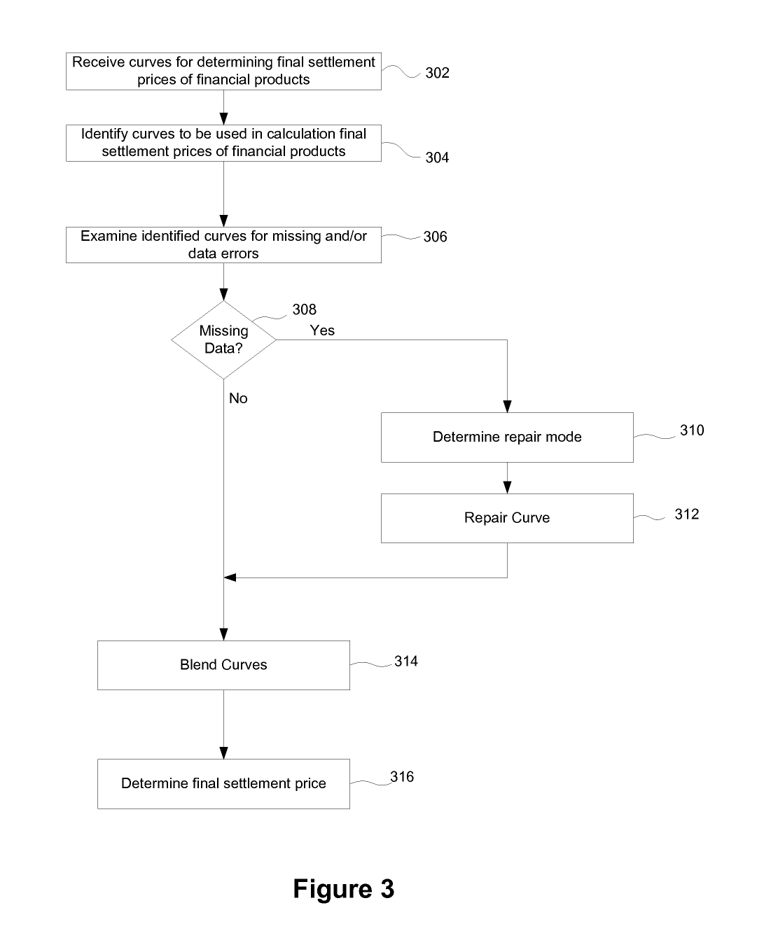

In an aspect of the invention, the fixing procedure may encompass a process which includes determining which prices are missing for various tenors of a selected financial instrument. In FIG. 3, a market maker may transmit price curves for use in determining final settlement prices. The price curves may be received at step 302 by a clearing house. The clearing house may determine which curves are to be used in determining the settlement prices at step 304 for various financial instruments. Next, in step 306, the price curves may be examined to determine if any prices/quotes are missing and/or whether the curves contain any errors. Moreover, the curves may be further analyzed to determine if the curves represent indicative curves or tradable curves. In step 308, a determination may be made as to whether the curves include a price for each tenor of a particular financial instrument. If a missing price is discovered, a repair mode may be selected at step 310. In an embodiment, the selected repair mode may be determined by the number of missing data points and/or the amount of time between received data points and the missing data point. Next, in step 312 a curve may be repaired based on the selected repair mode. In step 314, the selected curves including any repaired curves may be blended in step 314 to determine the final settlement price for the financial instrument in step 316.

Returning to step 308, if it is determined that the received price curve is complete then all of the selected curves may be blended together as indicated in step 314. The final settlement prices may be determined in step 316. The determined final settlement prices may be transmitted or broadcast to the market makers and/or other interested parties. In another embodiment, the blending may be completed on Swapstream.

In an aspect of the invention, a curve may be considered non-existent if it is logically switched off, physically disconnected, or if all of its price points are missing. Furthermore, in an embodiment, a data point (mid price for one swap) may be considered missing if: 1) it has never been sent, 2) it has been sent explicitly with a “NO VALUE” special value, and 3) it has not been updated since some time threshold (e.g. 3 seconds).

In yet another aspect of the invention, market makers may be required to contribute at least an indicative price for every 360 swaps (or 12 swaps for overnight swaps). In another embodiment, market makers may have a number of options in which to actually contribute their curves: either as (bid, offer) or (mid, margin), send every swap price in real time, or just send benchmark swap prices in real time and every other spread at a different pace.

In an aspect of the invention, mixing of an indicative curve and a tradable curve from a market maker might induce some inconsistencies. For instance, for one market maker its indicative curve may be favored as it is more complete than its tradable curve. However, in the case where an indicative curve is missing or less complete than the tradable curve, then the tradable curve may be used instead.

Considering one curve has been selected (either the indicative curve or the tradable curve), this curve may be referred to as “the indicative curve of the market maker” thereafter, and is only made of MID prices.

In another aspect of the invention, if the indicative curve for each market maker is complete for every swap, then the curve is kept unchanged. However, if prices are missing for some swaps, then the curve may have to be repaired before it may be used for blending.

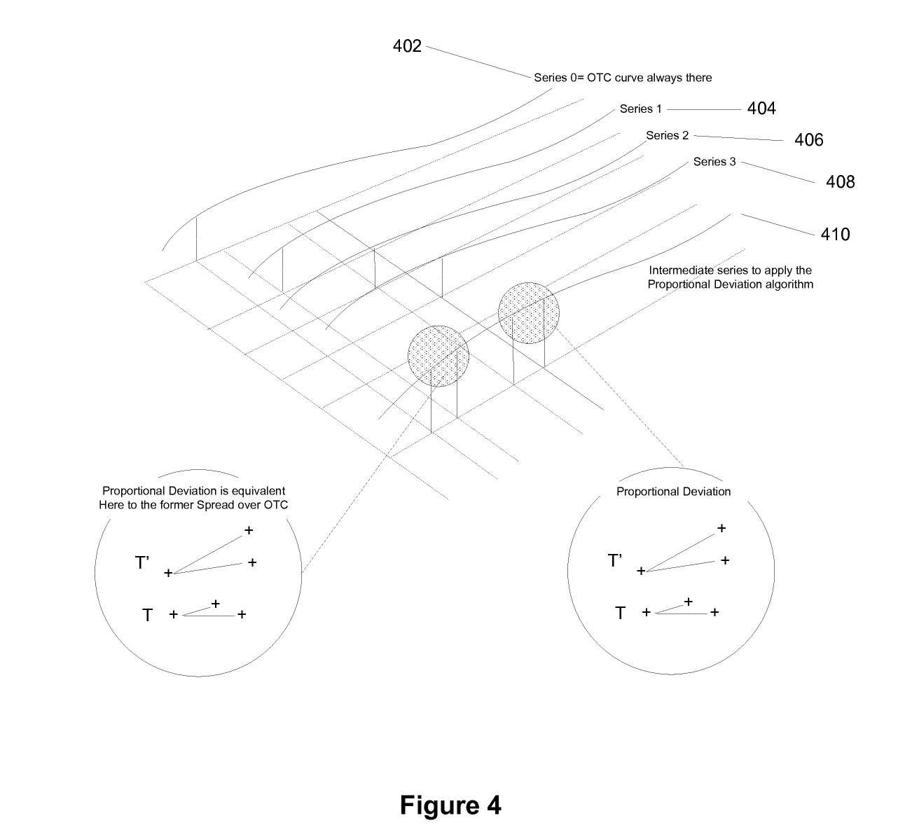

FIG. 4 illustrates the nominal mode in accordance with an aspect of the invention. In FIG. 4, each series (series-0 “402”, series-1 “404”, series-2 “406”, and series-3 “408) may be layered to apply a proportional deviation algorithm on the resulting series. Series-0 “402” may represent an OTC spot curve for annual maturities of interest swaps supplied from an external source such as Bloomberg.

In an aspect of the invention, the shape of the curves represented in FIG. 4 may be more stable than their absolute levels. Furthermore, in an aspect of the invention, the relative distance between “corresponding” points of two curves may also stable. In an embodiment, the spreads between any two points of any two curves may be linearly interpolated between themselves. In FIG. 4, various missing prices may be determined for an intermediate series-410.

In another exemplary embodiment and for illustrative purposes, it may be assumed that at a time T only the rates for 5Y, 6Y and 7Y are known for a particular financial instrument. Next, at a time of T+1 only 5Y and 7Y rates may be known. In accordance with an aspect of the invention, a linear interpolation of the offset from 5Y-to-6Y and of the offset from 7Y-to-6Y, may be calculated to determine a value for the missing 6Y rate that still preserves the shape of the curve in the range 5Y-7Y.

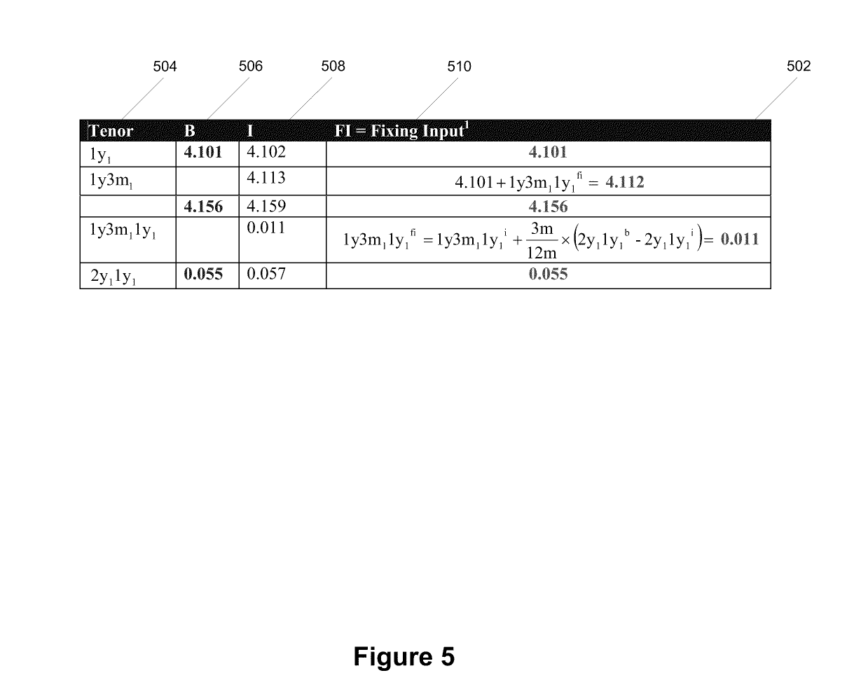

In another illustrative embodiment, a distribution of deviations is demonstrated and may be determined for series-1 and series-2 swaps of tenors: 1y, 1y3m, and 2y. In this embodiment, subscript ‘1’ is used to indicate series-1 swaps and subscript ‘2’ is used for series-2 swaps. FIG. 5 illustrates the fixing for series-1 with a start date of Sep. 19, 2007. In FIG. 5, table 502 includes 1y, 1y3m, and 2y tenors in column 504. Benchmark (B) rates in column 506 for 1y and 2y have been listed. Also the availability of indicative (I) spreads 2y-1y and 1y3m-1y have been presumed in column 508. The final column 510 shows the distribution of the deviation (0.2 bp) between the benchmark spreads and the indicative spreads (2y-1y). The final column 510 is titled fixing input (FI) to highlight the fact that the outcome may be input to the blending algorithm. In an aspect of the invention, all of the computations may be rounded to the nearest third decimal place to enforce the 1/10th of a basis point pricing constraint.

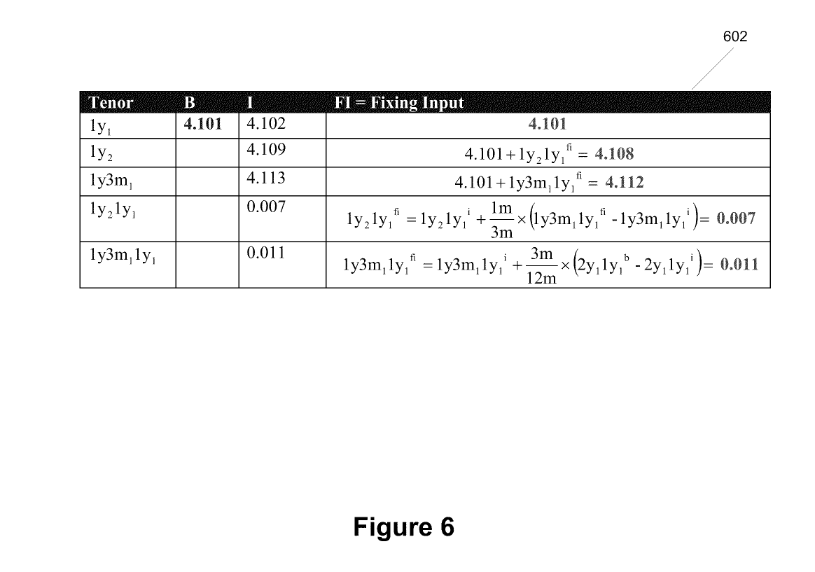

FIG. 6, table 602 illustrates a similar approach used to determine the fixing input for the series-2 swaps for a given market maker with a start date of Oct. 17, 2007 in accordance with an aspect of the invention.

In another aspect of the invention, a back up mode may be used to determine end-of-day settlement prices. In the back up mode, the spread between a cleared swap and its corresponding OTC swap is stable enough on an intraday basis. The backup mode or “forward OTC swap rates mode” may make use of external data sources to compute a settlement rate curve in cases where no market maker is available to provide settlement information. In another embodiment, the backup mode may be used in cases where significant gaps between different tenors exist for a particular forward starting instrument.

In an exemplary embodiment, assume that at time T the rate for the cleared (forward) swap and the white price of the same maturity OTC (spot) swap are known. If at time T+1, only the rate of the OTC swap is known, then the cleared rate of the same maturity may be derived from the OTC rate plus the spread between the cleared and OTC rates that were known at time T provided T and T+1 are intraday. Ideally, no major market event should take place between T and T+1.

In an aspect of the invention, the back up mode may be preferred over the nominal mode for spreads wider than one year maturities because the Series-0 OCT curve is a curve that exists with prices at least on every annual maturity. This may ensure that any missing point is never further than 6M away from points on the OTC curve.

Furthermore, if needed, forward OTC swap mid market rates may be downloaded from Bloomberg and stored for all tenored fixings in accordance with an aspect of the invention. These rates may be compared with other cleared fixings to track the basis, if any, between them.

In an embodiment of the invention, for Day 1 the back up mode fixing approach may apply the previous day settlement basis. When Cases A, B, and C cannot, for any reason be implemented, tenored fixings may be produced using the forward OTC rates from Bloomberg with the basis applied. The balance of fixings may be interpolated.

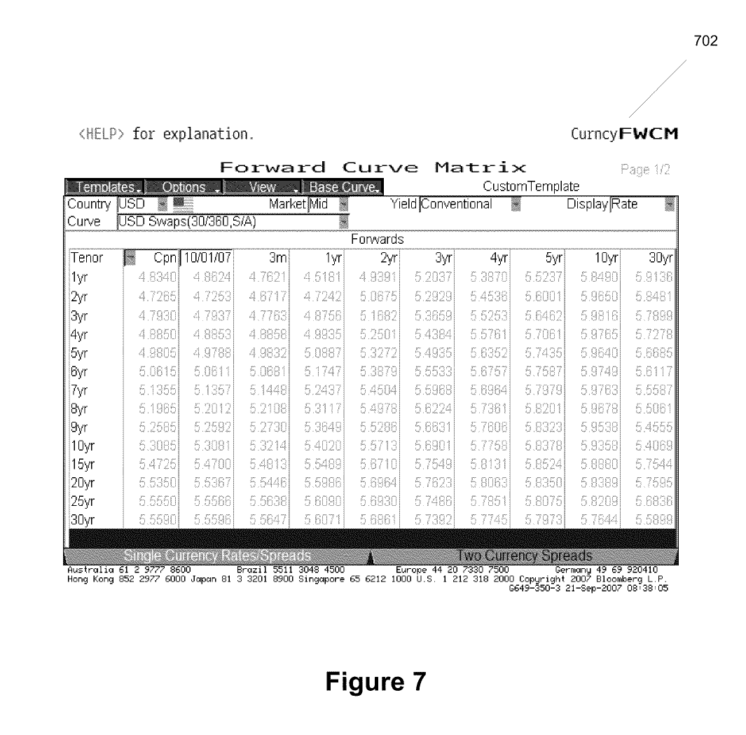

In another aspect of the invention, the Forward Curve Matrix, (FWCM page on Bloomberg, see FIG. 7 screen 702) may be used to calculate forward rates for interest rate swaps as far out as thirty years for USD and EUR. This is a transparent process whereby the FWCM page uses spot swap quotes from the Bloomberg IRSB page (Specific banks may be configured to populate IRSB page) and facilitates calculating forward swap rates using CME Cleared IMM dates.

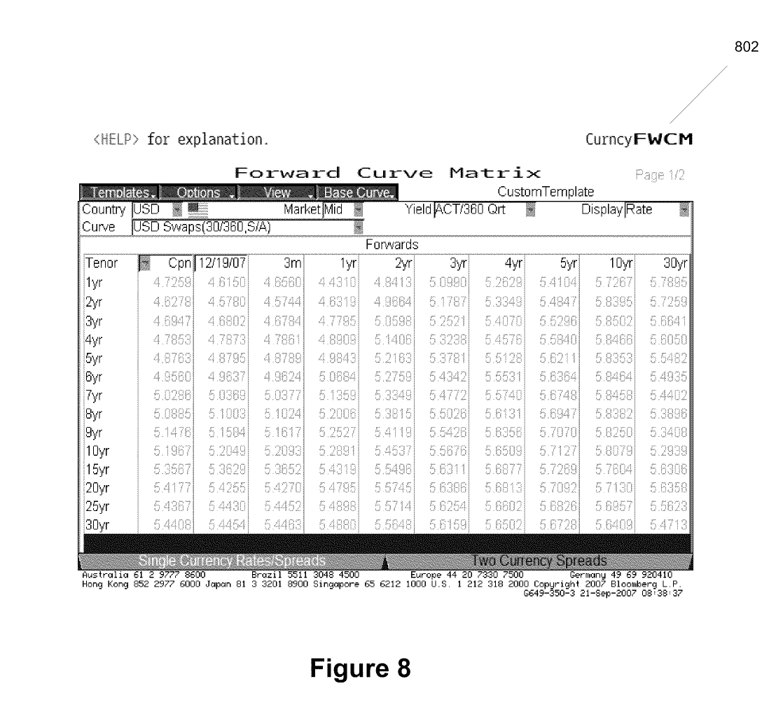

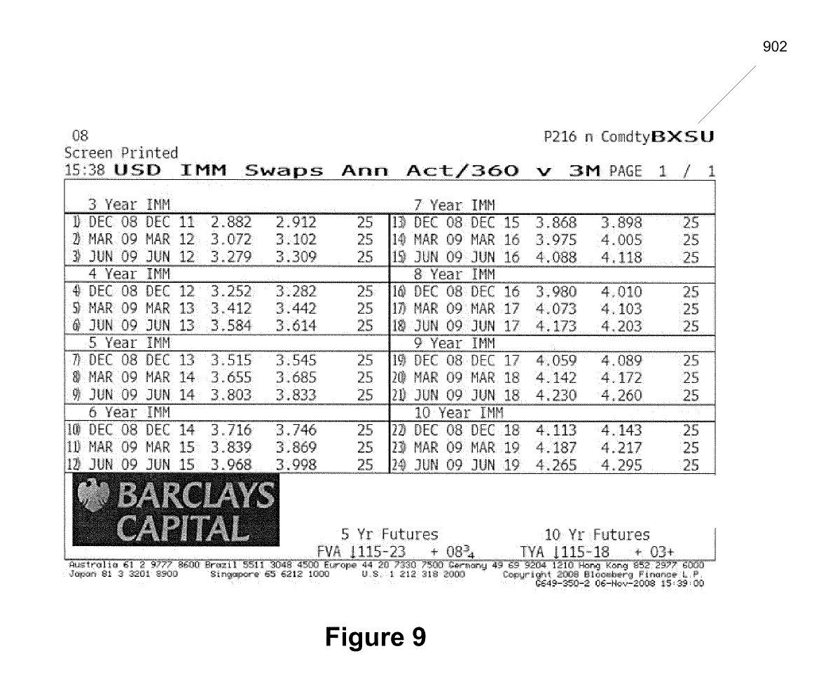

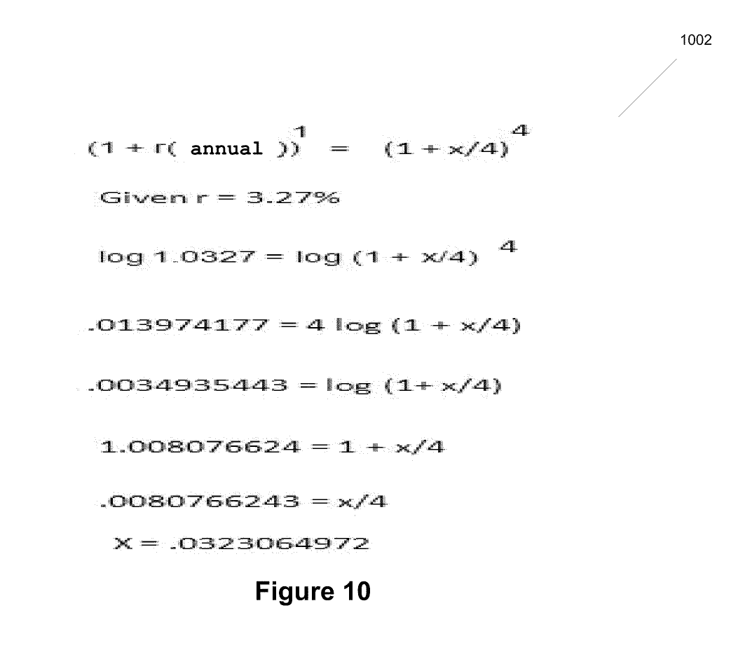

As backup, forward benchmark fixings may be calculated using the FWCM page on Bloomberg with the balance of tenors interpolated. This fixing procedure may take place at 10:00 AM CT for EUR and 2:00 PM CT for USD. In an embodiment, a spreadsheet may dynamically pull in the Bloomberg forward benchmark tenors using an ACT/360 quarterly convention for the three forward IMM start dates as illustrated in FIG. 8 screen 802. These forward levels may be calculated and compared with indicative CME Cleared market quotes or trades to establish a basis level, if any, between the calculated forwards from Bloomberg and CME Cleared. The basis may be applied and fixings established.

The FWCM page may facilitate pricing the swap curve forward with three consecutive start dates with tenors from one month to thirty years for USD and one month to fifty years for EUR. The FWCM page may dynamically pull in swap rates from the IRSB. The IRSB page pulls OTC swap rates from designated banks for updates. The FWCM page forward prices these spot rates. This forward calculation is published by Bloomberg.

CME Swaps on Swapstream are re-tenored two business days before the Wednesday start date. This forward calculated swap may or may not trade at a basis to the equivalent cleared swap. This basis can be recorded and tracked. FWCM can be used along with a recently established basis to provide benchmark fixings and generate fixings for all listed instruments using Cubic-Spline interpolation.

The forward ACT/360 quarterly rate may closely approximate traded/quoted CME Cleared rate, however, the degree of closeness remains to be seen and will be dictated by the market. The market may price the forward ACT/360 quarterly and the CME Cleared swap slightly different. This “basis” level may be tracked for the settlement process and used to price the cleared tenors off of the forward OTC.

In another aspect of the invention, Barclays Capital, (BXSU page on Bloomberg, see FIG. 9 screen 902) may be used to calculate forward rates for interest rate swaps from 3 to 10 years for USD. This is a transparent process that facilitates calculating forward swap rates using CME Cleared IMM dates. For instance, FIG. 10 illustrates a sample conversion 1002 from a Barclays IMM dated Annual Swap to a cleared convention. In the exemplary embodiment of FIG. 10, a USD four year IMM Swap rate is listed via BXSU as 3.27. As shown in FIG. 10, conversion of the Barclays IMM dated annual Swap to a cleared conversion is 3.23.

In another aspect of the invention, a blending algorithm may use the market maker's swap curves and determine a final fixing for the listed instruments. The blending algorithm may discard the outliers (similar to the ISDAFIX process where the highest ‘n’ prices are eliminated) and may average the remaining price for the fixing. In an embodiment, the blending algorithm may be similar to the algorithm used for generating ISDAFIX prices for rates. In another embodiment, the blending may be done on Swap stream.

In an aspect of the invention, the blending of mid market maker quotes may be as follows on a case (n) basis in the below state chart.

| n | fixing |
|---|---|
| 1 | fixing = quote |
| 2 | fixing = average of the two |
| 3 | fixing = take median, eliminate outlier (farthest from median), |
| | average remaining two (if no outlier, average high and low) |
| 4 | fixing = eliminate highest and lowest, average two |
| 5 | fixing = eliminate highest and lowest quote, average remaining |
| | three |
| 6 | fixing = eliminate highest and lowest quote, average remaining |
| | four |
| 7 | fixing = eliminate highest and lowest quote, average remaining |
| | five |
| 8 | fixing = eliminate two highest and two lowest quotes, average |
| | remaining four |
| 9 | fixing = eliminate two highest and two lowest quotes, average |
| | remaining five |
| 10 | fixing = eliminate two highest and two lowest quotes, average |
| | remaining six |

It should be understood that various changes and modifications to the presently preferred embodiments described herein will be apparent to those skilled in the art. Such changes and modifications can be made without departing from the teachings of the present invention and without diminishing its intended advantages. It is therefore intended that such changes and modifications be covered by the appended claims.

The present invention has been described herein with reference to specific exemplary embodiments thereof. It will be apparent to those skilled in the art that a person understanding this invention may conceive of changes or other embodiments or variations, which utilize the principles of this invention without departing from the broader spirit and scope of the invention as set forth in the appended exemplary aspects of the invention. All are considered within the sphere, spirit, and scope of the invention.

We claim:

1. A computer-implemented method of determining a settlement price for an over-the-counter exchange traded financial instrument, the computer-implemented method comprising:
(a) receiving price curves for a financial instrument;
(b) identifying price curves to be used to determine a settlement price for the financial instrument;
(c) determining if any of the identified price curves include missing quotes for different tenors associated with the price curve;
(d) blending using a processor the identified price curves; and
(e) determining using a processor a final settlement price for the over-the-counter exchange traded financial instrument.

2. A computer-implemented method of determining a settlement price for an over-the-counter exchange traded financial instrument, the method comprising:
(a) receiving price curves for a financial instrument;
(b) identifying price curves to be used to determine a settlement price for the financial instrument;
(c) determining if any of the identified price curves include missing quotes for different tenors associated with the price curve;
if an identified curve includes a missing quote,
(d) repairing the identified price curve;
(e) blending using a processor the identified price curves; and
(f) determining using a processor a final settlement price for the over-the-counter exchange traded financial instrument.

3. The computer-implemented method of claim 2, wherein step (c) further comprises the step of:
(g) determining a repair mode used to repair the identified price curve.

4. The computer-implemented method of claim 3, wherein the determined repair mode comprises a nominal repair mode.

5. The computer-implemented method of claim 3, wherein the determined repair mode comprises a back up mode.

6. The computer-implemented method of claim 3, wherein the step of determining a repair mode used to repair the identified price curve further comprises determining the number of missing quotes for the identified price curve.

7. The computer-implemented method of claim 2, further including: (g) transmitting the determined final settlement price for the over-the-counter exchange traded financial instrument.

8. The computer-implemented method of claim 2, wherein the financial instrument comprises a Euro denominated interest rate swap.

9. The computer-implemented method of claim 2, wherein the financial instrument comprises a U.S. denominated interest rate swap.

10. The computer-implemented method of claim 2, wherein the financial instrument comprises a OIS interest rate swap.

11. The computer-implemented method of claim 5, wherein the back up mode includes using a swap mid market rate price.

12. The computer-implemented method of claim 2, further comprising (g) determining if the received price curves include indicative price curves.

13. The computer-implemented method of claim 2, further comprising (g) determining if the received price curves include tradable price curves.

14. A computer-readable medium including computer-executable instructions for causing a computer device to perform the steps comprising:
(a) receiving price curves for a financial instrument;
(b) identifying price curves to be used to determine a settlement price for the financial instrument;
(c) determining if any of the identified price curves include missing quotes for different tenors associated with the price curve;
if an identified curve includes a missing quote,
(d) repairing the identified price curve;
(e) blending the identified price curves; and
(f) determining a final settlement price for the over-the-counter exchange traded financial instrument.

15. The computer-readable of claim 14, wherein step (c) further comprises the step of:
(g) determining a repair mode used to repair the identified price curve.

16. The computer-readable medium of claim 14, wherein the determined repair mode comprises a nominal repair mode.

17. The computer-readable medium of claim 14, wherein the determined repair mode comprises a back up mode.

18. The computer-readable medium of claim 14, further comprising (g) determining if the received price curves include indicative price curves.

19. The computer-readable medium of claim 14, further comprising (g) determining if the received price curves include tradable price curves.

20. The computer-readable medium of claim 17, the back up mode includes using a swap mid market rate price.
